(19) United States
(12) Patent Application Publication
(10) Pub. No.: US 2017/0286631 A1
(43) Pub. Date: Oct. 5, 2017

(54) TEXT ANALYTICS ON RELATIONAL MEDICAL DATA

(71) Applicant: International Business Machines Corporation, Armonk, NY (US)

(72) Inventors: Dhruv A. Bhatt, Indian Trail, NC (US); Bhargav Cheenepalli, Charlotte, NC (US); Kristin E. McNeil, Charlotte, NC (US); Nitaben A. Patel, Charlotte, NC (US)

(21) Appl. No.: 15/086,280

(22) Filed: Mar. 31, 2016

(51) Int. Cl. G06F 19/00

(52) U.S. Cl. CPC G06F 19/3443

(57) ABSTRACT

A system can associate a life event and a medical condition for a particular patient by identifying the life event using text analysis for the patient's medical records. Medical data associated with the life event can be extracted, and it can be determined that the life event impacts other patients. The medical records for the other patients can then be analyzed, and the medical data relevant to the patient's life event can be extracted. Using the extracted medical data, a medical condition for the primary patient can be determined, and a relationship between the life event and the medical condition can be transmitted.

### BACKGROUND

The present disclosure relates to performing textual analytics on unstructured data, and more specifically, to processing unstructured data including medical records.

Unstructured data may refer to information that either does not have a pre-defined data model or is not organized in a pre-defined manner. Unstructured data may be text-heavy; it may contain data such as dates and numbers as well. The combination of text, number, and dates data without a pre-defined model or organization scheme may result in irregularities and ambiguities that can make the unstructured data difficult to understand using traditional programs. Techniques such as data mining, natural language processing (NLP), and text analytics may provide different methods to find patterns in, or otherwise interpret, this information.

### SUMMARY

Embodiments of the present disclosure may be directed toward a method that begins by identifying a life event for a primary patient. This identification is based on results of text analytics that are performed on a set of medical records. Medical data associated with the life event can then be extracted from the set of medical records. The medical data may be associated by occurring in a time frame of the life event. The life event of the primary patient may be determined to impact a set of secondary patients. A set of medical records associated with each secondary patient in the set of secondary patients may be analyzed for each secondary patient in the set of secondary patients. The analyzing may result in the identification of secondary medical data, where the secondary medical data is associated with the primary patient. The secondary medical data associated with the primary patient can then be extracted based on the analyzing for each secondary patient. Based on the extracted medical data associated with the life event, extracted secondary medical data and a set of medical dictionaries and rules, a medical condition for the primary patient can be determined. A relationship between the life event and the medical condition can be transmitted.

Embodiments of the present disclosure may be directed toward a computer system comprising at least one processor circuit configured to identify a life event for a primary patient. The identification can be based on results of text analytics performed on a set of medical records. The system can extract medical data associated with the life event from the set of medical records. The medical data may be associated with the life event by occurring in a time frame of the life event. The system can then determine the life event of the primary patient impacts a set of secondary patients. A set of medical records associated with each secondary patient in the set of secondary patients can be analyzed. The analyzing can result in the identification of secondary medical data, where the secondary medical data is associated with the primary patient. The system can extract the secondary medical data associated with the primary patient based on the analyzing for each secondary patient. The system can then determine a medical condition for the primary patient based on: the extracted medical data associated with the life event, the extracted secondary medical data associated with the primary patient, and a set of medical dictionaries and rules. The system can then transmit a relationship between the life event and the medical condition based on the determining the medical condition.

Embodiments of the present disclosure may be directed toward a computer program product for identifying a relationship between a life event and a medical condition. The computer program product may have a computer readable storage medium with program instructions embodied within, where the computer readable storage medium is not a transitory signal per se. The program instructions may be executable by a computer processing circuit to cause the circuit to perform a method. The method may begin by identifying a life event for a primary patient. This identification is based on results of text analytics that are performed on a set of medical records. Medical data associated with the life event can then be extracted from the set of medical records. The medical data may be associated by occurring in a time frame of the life event. The life event of the primary patient may be determined to impact a set of secondary patients. A set of medical records associated with each secondary patient in the set of secondary patients may be analyzed for each secondary patient in the set of secondary patients. The analyzing may result in the identification of secondary medical data, where the secondary medical data is associated with the primary patient. The secondary medical data associated with the primary patient can then be extracted based on the analyzing for each secondary patient. Based on the extracted medical data associated with the life event, extracted secondary medical data and a set of medical dictionaries and rules, a medical condition for the primary patient can be determined. A relationship between the life event and the medical condition can be transmitted.

The above summary is not intended to describe each illustrated embodiment or every implementation of the present disclosure.

### BRIEF DESCRIPTION OF THE DRAWINGS

The drawings included in the present application are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 depicts a diagram of a system for identifying relationships between data in medical records, according to embodiments.

FIG. 2 depicts a flow diagram of a method for identifying a relationship between a life event and a medical condition, according to embodiments.

FIG. 3 depicts a flow diagram of a system for diagnosing a patient using textual analysis on structured and unstructured data sources, according to embodiments.

FIG. 4 depicts a cloud computing environment according to embodiments of the present disclosure.

FIG. 5 depicts abstraction model layers according to embodiments of the present disclosure.

FIG. 6 depicts representative major components of an example computer system that may be used according to embodiments of the present disclosure.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention.

### DETAILED DESCRIPTION

Aspects of the present disclosure relate to text analytics, more particular aspects relate to medical diagnosis based on textual analysis of medical records. While the present disclosure is not necessarily limited to such applications, various aspects of the disclosure may be appreciated through a discussion of various examples using this context.

In healthcare, medical data can be evaluated and used to understand a patient and his conditions. For certain types of data, context associated with the data may be helpful in determining the usefulness and application of the data to the patient (e.g., for diagnosis, treatment, etc.). A patient's life may be filled with a number of events that can potentially impact the patient's health and overall wellbeing. In some cases, these life events may not be considered formal medical events, but rather life events that are impactful on the patient's physical, mental, or emotional health. Life events may include, for example, a recent loss of a loved one, a compromised living situation (e.g., homelessness), a pre-surgery period, a post-surgery period, pregnancy, changes in relationship status, or other life events. In addition to impacting the patient's own well-being, many of these life events may impact one or more other persons related (e.g., either biologically or relationally) to the patient.

For example, a patient may have been a smoker for her first five years of being a parent. Smoking during this time period could be a life event. This life event could impact the patient's personal health and wellbeing. The patient's children may be impacted as well, as they may have been exposed to second hand smoke on a semi-regular basis.

In embodiments, a method may be carried out by a system over a set of one or more processing circuits. First, a life event for the patient (e.g., adopted at age twelve) may be identified. In order to identify this life event, a set of medical records may be analyzed using textual analysis. In this way, documents including, for example, doctors' notes and other unstructured data can be used in performing the identification. Once a particular life event of the patient has been identified, medical data that is associated with the life event can be extracted from the medical records. In embodiments, medical data may be associated with the life event if it occurs over the time period during which the life event has occurred. For example, if a patient was adopted at age twelve, and thus lived with a particular set of parents from age twelve to eighteen, medical data for the patient for ages twelve to eighteen can be extracted.

It can then be determined that the life event (e.g., adopted at age twelve) may impact one or more other persons. This group of other persons, or secondary patients, can include family members, close friends, care givers, or another person or set of persons who may be impacted by the life event. For example, if the life event for the primary patient is that she was adopted at age twelve, the set of secondary patients may include: her adoptive parents, her new caregivers over the time period, and any adoptive siblings who may have lived in the new home.

The medical records for each of these secondary patients may then be securely analyzed, using the same or similar textual analytics techniques as performed on the medical records of the primary patient. The medical records may be analyzed for medical data that may be associated with or connected to the primary patient in some way. For example, medical records of one of the adoptive parents may contain data that the parent was a smoker for a year following the adoption. This medical data from the medical records of the secondary patient (e.g., the parent) may be associated with the primary patient, in that the primary patient may have been exposed to secondhand smoke during that year. The system can then extract that relevant medical data.

This extracted medical data from the primary and secondary patients' medical records can be used in conjunction with other data, for example, the current medical evaluation data obtained at a most recent physician's visit, and compared against a set of current standards including medical dictionaries and rules, to determine a medical condition for the primary patient. For example, the primary patient's medical data over the life event (e.g., adoption), as well as the medical data for the secondary patient over the time of the life event in the primary patient's life (e.g., that the adoptive parent smoked during the first year following the patient's adoption) may be used in conjunction with the current symptoms with which the patient presented at a most recent doctor visit to form a set of symptom data. This symptom data can then be compared against a set of medical dictionaries and rules in order to determine a medical condition for the primary patient, for example, that the patient may be suffering from asthma. In some embodiments, the set of medical dictionaries and rules may include the IBM ADVANCED CARE INSIGHTS. This determination can then be displayed to a user, along with the life event that may be relevant to the diagnosis.

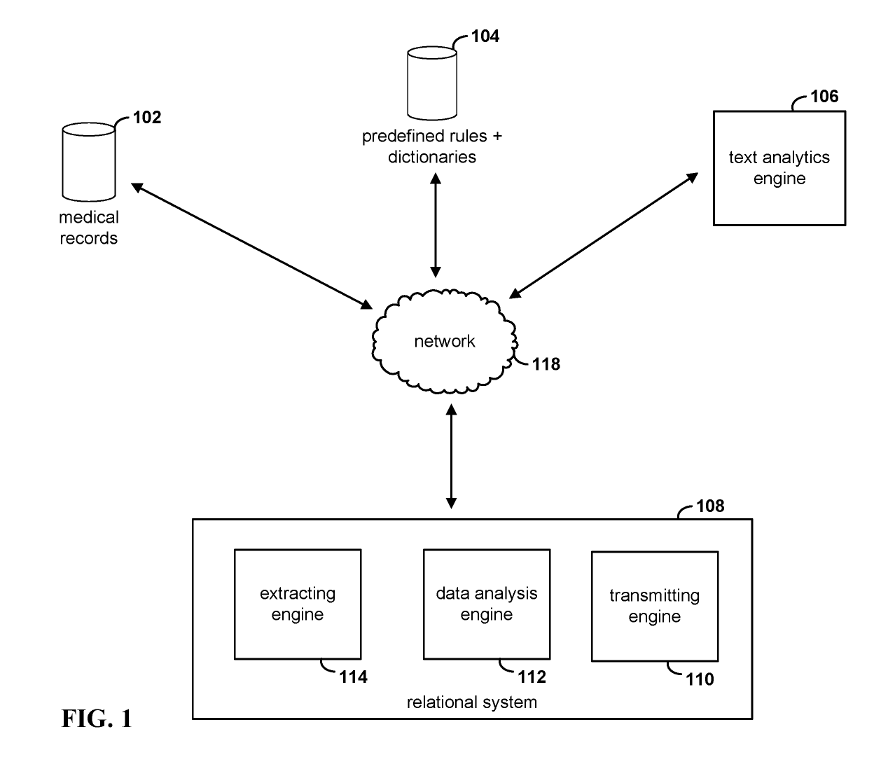

FIG. 1 depicts a diagram of a system for identifying relationships between data in medical records, according to embodiments. In embodiments, a text analytics engine 106 may communicate with one or more databases over a network 118. The network 118 can be networks including, but not limited to, local area networks, point-to-point communications, wide area networks, the Internet, an intranet, and combinations thereof. The text analytics engine 106 may perform text analytics on a set of medical records contained within a medical records database 102. The medical records database may contain structured and unstructured text from documents and sources including, but not limited to, a patient's electronic medical records (EMR), digitized medical records, doctors' notes, prescription receipts, insurance data, wearable device data, or other data.

A relational system 108 may be used to identify relationships between a patient's life events, medical data about other, related patients, and one or more medical conditions, as described herein. The relational system 108 may comprise an extracting engine 114, a data analysis engine 112, and a transmitting engine 110. The relational system 108 may have more or fewer engines than those described here, as the current description is for illustrative purposes only. The transmitting engine 110 of the relational system 108 may transmit or receive data. The transmitting engine 110 may receive, from the text analytics engine 106, over the network 118, textual analysis of a particular patient's medical records. From the received data, the data analysis engine 112 may identify a life event for the primary patient. For example, a patient may be participating in preoperative (pre-op) and postoperative (post-op) medical care for a child before a major medical operation. This could be identified as a life event for the particular patient. The extracting engine of the relational system 108 could then extract, from the medical records 102, medical data that is associated with the time frame of the life event. For example, the extracting engine 114 could extract medical data from the medical records 102 for a time period that begins at the onset of the life event (as determined by, e.g., the data analysis engine 112), and ends at the conclusion of the life event (also determined by, e.g., the data analysis engine 112). For example, the pre-op medical care for the patient's child may be determined to begin two months prior to the operation and the post-op care may be determined to have lasted for the ten months following the operation. Thus, the medical data, associated with the time frame of the pre-op and post-op care, to be extracted, may be the data present in the medical records over the span of the year beginning two months prior to the operation and ending ten months following the operation.

The data analysis engine 112 can determine that the life event may impact a set of secondary patients. For example, the impact could be a direct impact or a more attenuated impact, including direct physical impact or a psychological impact. In embodiments, the impact may be relational, in that, for example, due to the life event, a relationship between the patient and a secondary patient may have been formed, ended, or changed. For example, the patient's child, the child who underwent the surgery, may be identified as a secondary patient. In this example, the relationship between the patient and the child may change, as the patient may spend more direct time with the child, and the time spent may be in a more stressful environment than previously. The data analysis engine 112 may determine this relationship or set of relationships based on data received from the text analytics engine 106 via the transmitting engine 110. The data analysis engine 112 may compare the analyzed medical record data with a set of rules received via the transmitting engine 110 from a predefined rules and dictionaries database 104, over the network 118. The predefined rules and dictionaries database 104 may contain a set of rules that define various relationships relevant to the medical context.

The relational system 108 can work in conjunction with the text analytics engine 106 to analyze and extract the relevant medical data for each of the secondary patients. The text analytics engine 106 can perform textual analysis on medical records associated with each of a set of secondary patients. In embodiments, these medical records may be accessed from a medical records database 102. As a result, an engine of the relational system 108, for example the data analysis engine 112, can identify secondary medical data in each of the secondary patients' medical records. This secondary medical data may be data found in the medical records of a secondary patient that may be associated with the primary patient. The extracting engine 114 of the relational system 108 may then extract the secondary medical data that may be associated with the primary patient.

The data analysis engine 112 of the relational system 108 can then access a set of medical dictionaries and rules, located in, for example, the predefined rules and dictionaries database 104. The secondary medical data as well as the extracted medical data for the primary patient during the life event may be then compared against the accessed medical dictionaries and rules. From the comparison, the data analysis engine 112 can determine a medical condition for the primary patient. For example, the system could determine that, based on symptoms and other medical data, the patient is currently suffering from acute high blood pressure.

The transmitting engine 110 of the relational system 108 can then transmit a relationship between the life event for the patient and the medical condition. The relationship data may be transmitted to a display, to another system, or to another destination for use in diagnosis or other medical use. The transmitting engine 110 may also transmit the relationship to a user device, to cause the user device to display the relationship. In some embodiments, the relationship may be displayed for the single patient, or it may be aggregated with data for other patients. In some embodiments, the relationship may be displayed for a patient, accompanied by other relevant data for the patient. For example, the system could transmit a relationship between the life event, “pre-op and post-op care of child” and the patient's high blood pressure. This data could then be used by a physician in determining the overall wellness of the patient or in identifying or ruling out a diagnosis based on the understanding that the patient had recently been under a period of acute stress, which could possibly be a contributor to the current high blood pressure, rather than, for example, coronary blockage, or another more serious cause.

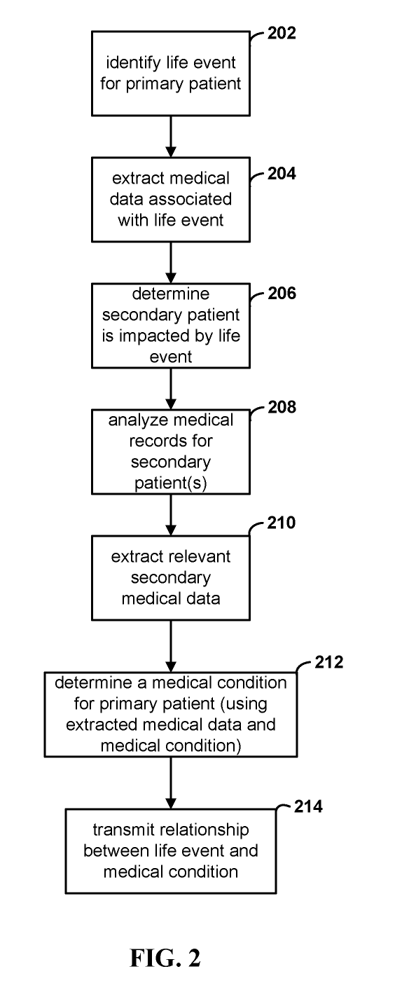

FIG. 2 depicts a flow diagram of a method for identifying a relationship between a life event and a medical condition, according to embodiments. The method may begin when the system identifies a life event for a primary patient, per 202. In embodiments, the system may be the relational system 108 of FIG. 1. The system may receive data that has been analyzed using one or more textual analysis techniques, and from the data identify the life event for the primary patient. The system may then extract medical data associated with the life event, per 204. This data may be extracted from a set of medical records, which may include digitized versions of traditional medical records and EMRs. The medical records may also include unstructured data including, for example, notes from a series of medical professionals including physicians, nurses, or other specialists; prescription information; data collected from a phone application or a wearable device; or other data.

The system may then determine that a secondary patient may be impacted by the life event, per 206. As used herein, the secondary patient or set of secondary patients may include any person or persons who are in some relationship with the primary patient, and whose medical data may be relevant to a holistic understanding of the primary patient's wellness. These relationships could include, for example, familial relations including parent, child, sibling, aunt, uncle, or other relative. The relationships could also be professional, caregiving, or domestic relationships including nurse, in-home care giver, roommate, or other relationship which could significantly impact the patient's wellbeing (from, e.g., stability of living environment, second-hand smoke, other toxic exposure, etc.).

The system may then analyze medical records for the secondary patient, per 208. The system may analyze the records to identify secondary medical data. This secondary medical data may be the data in the secondary patient's medical record that is associated with the primary patient. In embodiments, this secondary medical data may be associated with the primary patient only during the time period of the life event in the primary patient's life. In other embodiments, it may be any data that may be associated with the primary patient.

The system may then extract the relevant secondary medical data, per 210, in order to provide it to an analyzing engine, for example the data analysis engine 112 of FIG. 1, for use in determining a medical condition for the first patient. The medical condition for the primary patient can then be determined using data including the extracted secondary medical data, extracted medical data for the primary patient during the life event, and a set of medical dictionaries and rules, per 212. This medical condition can be associated with the life event and transmitted for use by another system, display, or another use, per 214. In this way, a medical condition may be associated with a particular life event over a particular period of time. Additionally, the identification of the medical condition also takes into consideration the relational context of the patient, allowing for a more informed view of medical diagnosis.

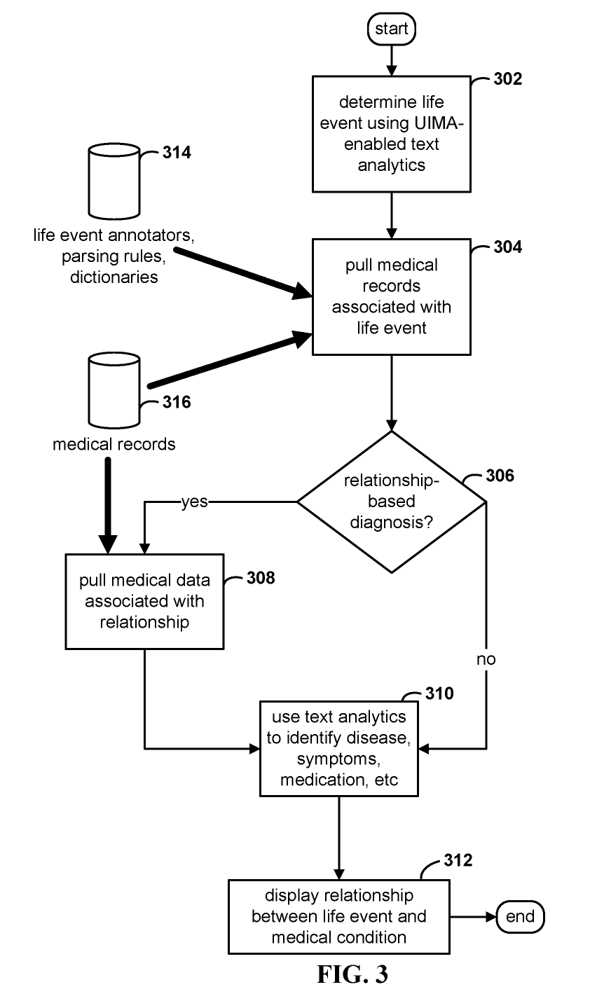

FIG. 3 depicts a flow diagram of a system for diagnosing a patient using textual analysis on structured and unstructured data sources, according to embodiments. The method may start when the system determines a life event exists in a data source using unstructured information management architecture (UIMA)-enabled text analytics (as described herein), per 302. The system may then pull medical records associated with the life event, per 304. In embodiments, the records can be pulled from a medical record database (e.g., medical records database 102 of FIG. 1), by, for example, an extracting engine (e.g., extracting engine 114 of FIG. 1). The system may use data from a database 314 that includes event annotators, parsing rules, and dictionaries, in order to determine which medical records are associated with the life event. The system may also access a database of medical records 316 from which a subset of medical records associated with the life event may be pulled.

In embodiments, the system may then determine whether or not the potential diagnosis for this patient, based on the life event, is one that may be relationship-based, per 306. If the system determines that the diagnosis may impact or be impacted by one or more other persons (e.g., secondary patients), the system may then pull data associated with the relationship, per 308. In this case, an extraction engine (e.g., extracting engine 114 of FIG. 1) may extract the appropriate medical data from the set of medical records 316. The system may then use text analytics to identify, from the data, a disease, relevant symptoms, appropriate medication, or other data relevant to a medical condition diagnosis, per 310.

If at 306, the system determines that the diagnosis for the patient is not necessarily relationship-based, then the system may analyze the patient's medical record data pulled at 304, in order to identify relevant disease, symptom, medications, or other data, per 310. The system can then display the relationship between the identified life event and the medical condition, per 312. In embodiments, the relationship between the life event and the medical condition may be transmitted outside of the system to a particular display, client device (e.g., smart phone, wearable device, or laptop computer), or other system. Following the display and/or transmission, the method may end.

In some embodiments, text analytics may be utilized to identify relevant data from sources, including medical records and other structured or unstructured text. Text analytics can be used to identify, from the sources life events, time periods of events, medical symptoms, medical diseases, medications, lab values, procedures from medical records, or other data.

In some embodiments, a text analytics engine could be built using UIMA. The architecture could include dictionaries that contain a list of words and rules to determine the identification of the text. Text analytics could be used to identify the existence of types of information from a source, the data including, for example, a medical disease, a procedure, a lab value, medication, the presence of smoking, and symptoms.

In addition, other dictionaries may be built to identify the life event, as well as a start and end data of the event. An example annotation may include:

Life Event Annotation

Start date (feature)

End date (feature)

As the start date and end date may vary based on patient, the life event can also be used to group patients together for a period of time that may be unique to each patient, in order to determine various aspects (e.g., symptoms, events, etc.), that may have been causes of later events.

Upon identification of a life event for a particular patient, the time frame for this event may be used to extract other data from both structured and unstructured text sources, including, for example, medical symptoms, medical diseases, medications, lab values, procedures from medical records, or other relevant medical data, during the particular time frame over which the life event occurred. For example, pregnancy may be identified as a life event. In response, the child's medical data could be combined with extracted medical data from the mother's medical records during the time frame of the mother's pregnancy.

In some embodiments, data may be sorted by the system and used to address one or more aspects of a particular medical condition. A medical condition could include examples such as a medical treatment, a lifestyle change, or a symptom. For example, the system could identify a life event, and a set of medical records associated with the timing of the life event. The system could then perform text analytics on this set of data, and, among other things sort the data into particular categories. For example, the categories being used to sort a particular set of medical data could be categories of lifestyle change. In this case, the textual analysis could tag relevant medical data to sort it into various categories including, for example, exercise, a smoking cessation program, dietary shift, or others. Thus, if a physician noted in a patient's medical records during the particular life event of interest, that a particular exercise program had been recommended and that the patient had begun participating in the program for the past month, this medical data could be assigned to the “exercise” category of lifestyle change. In this way, associations between lifestyle changes, or other medical concepts, and various medical conditions can be determined.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

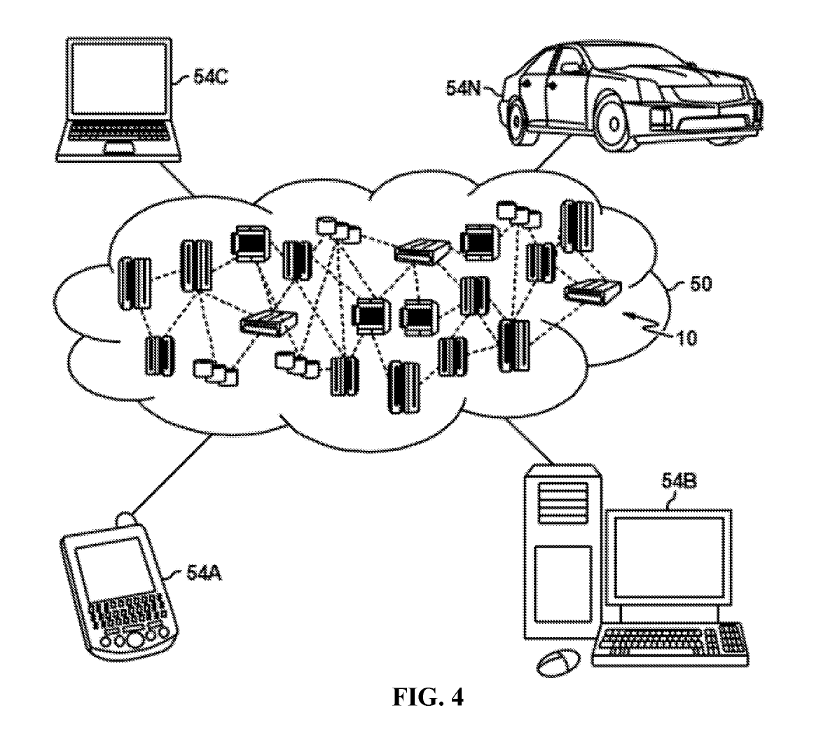

Referring now to FIG. 4, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 4 are intended to be illustrative only and that computing nodes 10 and cloud computing environment 50 can communicate with any type of computerized device over any type of network and/or network addressable connection (e.g., using a web browser).

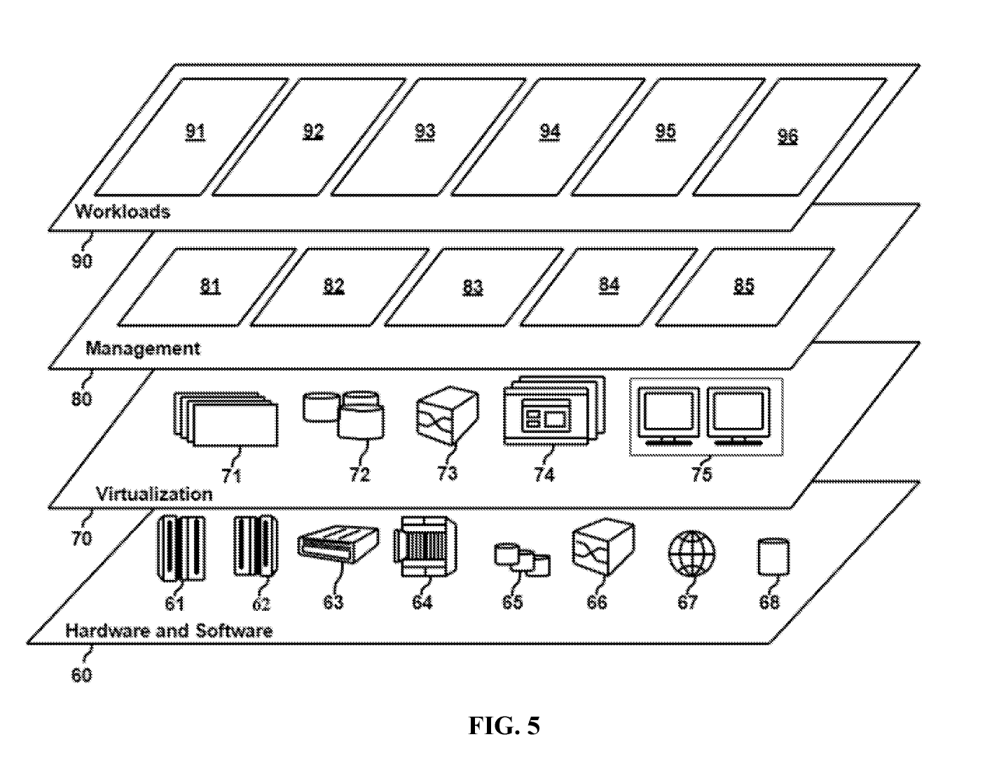

Referring now to FIG. 5, a set of functional abstraction layers provided by cloud computing environment 50 (FIG. 4) is shown. It should be understood in advance that the components, layers, and functions shown in FIG. 5 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and relating medical data 96.

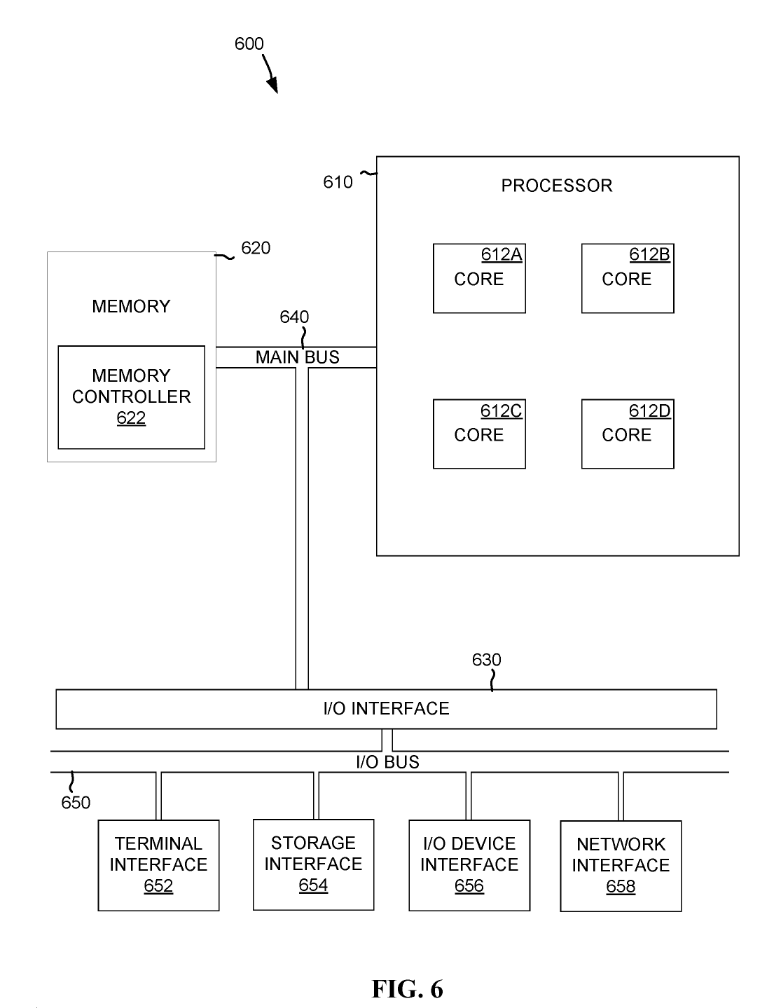

FIG. 6 depicts the representative major components of an example computer system 600 that may be used, in accordance with embodiments of the present disclosure. It is appreciated that individual components may vary in complexity, number, type, and\or configuration. The particular examples disclosed are for example purposes only and are not necessarily the only such variations. The computer system 600 may comprise a processor 610, memory 620, an input/output interface (herein I/O or I/O interface) 630, and a main bus 640. The main bus 640 may provide communication pathways for the other components of the computer system 600. In some embodiments, the main bus 640 may connect to other components such as a specialized digital signal processor (not depicted).

The processor 610 of the computer system 600 may be comprised of one or more cores 612A, 612B, 612C, 612D (collectively 612). The processor 610 may additionally include one or more memory buffers or caches (not depicted) that provide temporary storage of instructions and data for the cores 612. The cores 612 may perform instructions on input provided from the caches or from the memory 620 and output the result to caches or the memory. The cores 612 may be comprised of one or more circuits configured to perform one or methods consistent with embodiments of the present disclosure. In some embodiments, the computer system 600 may contain multiple processors 610. In some embodiments, the computer system 600 may be a single processor 610 with a singular core 612.

The memory 620 of the computer system 601 may include a memory controller 622. In some embodiments, the memory 620 may comprise a random-access semiconductor memory, storage device, or storage medium (either volatile or non-volatile) for storing data and programs. In some embodiments, the memory may be in the form of modules (e.g., dual in-line memory modules). The memory controller 622 may communicate with the processor 610, facilitating storage and retrieval of information in the memory 620. The memory controller 622 may communicate with the I/O interface 630, facilitating storage and retrieval of input or output in the memory 620.

The I/O interface 630 may comprise an I/O bus 650, a terminal interface 652, a storage interface 654, an I/O device interface 656, and a network interface 658. The I/O interface 630 may connect the main bus 640 to the I/O bus 650. The I/O interface 630 may direct instructions and data from the processor 610 and memory 620 to the various interfaces of the I/O bus 650. The I/O interface 630 may also direct instructions and data from the various interfaces of the I/O bus 650 to the processor 610 and memory 620. The various interfaces may include the terminal interface 652, the storage interface 654, the I/O device interface 656, and the network interface 658. In some embodiments, the various interfaces may include a subset of the aforementioned interfaces (e.g., an embedded computer system in an industrial application may not include the terminal interface 652 and the storage interface 654).

Logic modules throughout the computer system 600—including but not limited to the memory 620, the processor 610, and the I/O interface 630—may communicate failures and changes to one or more components to a hypervisor or operating system (not depicted). The hypervisor or the operating system may allocate the various resources available in the computer system 600 and track the location of data in memory 620 and of processes assigned to various cores 612. In embodiments that combine or rearrange elements, aspects and capabilities of the logic modules may be combined or redistributed. These variations would be apparent to one skilled in the art.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

What is claimed is:

1. A method comprising:
identifying a life event for a primary patient, the identifying based on results of text analytics performed on a set of medical records;
extracting, from the set of medical records, medical data associated with the life event, the medical data being associated by occurring in a time frame of the life event;
determining the life event of the primary patient impacts a set of secondary patients;
analyzing, for each secondary patient in the set of secondary patients, a set of medical records associated with each secondary patient in the set of secondary patients, the analyzing resulting in the identification of secondary medical data, the secondary medical data associated with the primary patient;
extracting, based on the analyzing for each secondary patient, the secondary medical data associated with the primary patient;
determining, based on the extracted medical data associated with the life event, the extracted secondary medical data associated with the primary patient, and a set of medical dictionaries and rules, a medical condition for the primary patient; and
transmitting, based on the determining the medical condition, a relationship between the life event and the medical condition.

2. The method of claim 1, wherein the set of medical dictionaries and rules comprise data mined from data sources accessed over the Internet.

3. The method of claim 1, wherein the medical records include unstructured data.

4. The method of claim 1, wherein the method further comprises, prior to the identifying the life event for the primary patient, performing text analytics on the set of medical records.

5. The method of claim 1, wherein the set of medical records associated with each of the secondary patients includes unstructured data.

6. The method of claim 4, wherein performing text analytics on the set of medical records comprises sorting medical records data into categories, wherein each category is associated with a particular aspect of a medical concept.

7. The method of claim 6, wherein the medical concept is a medical treatment.

8. The method of claim 6, wherein the medical concept is a lifestyle change.

9. The method of claim 6, wherein the medical concept is a symptom.

10. The method of claim 1, wherein the set of medical dictionaries and rules comprise the IBM Advanced Care Insights.

11. The method of claim 1, wherein the transmitting further comprises transmitting the relationship to a user device, to cause the user device to display the relationship between the life event and the medical condition.

12. A computer system comprising:
at least one processor circuit configured to:
identify a life event for a primary patient, the identification based on results of text analytics performed on a set of medical records;
extract, from the set of medical records, medical data associated with the life event, the medical data being associated by occurring in a time frame of the life event;
determine the life event of the primary patient impacts a set of secondary patients;
analyze, for each secondary patient in the set of secondary patients, a set of medical records associated with each secondary patient in the set of secondary patients, the analysis resulting in the identification of secondary medical data, the secondary medical data associated with the primary patient;
extract, based on the analyzing for each secondary patient, the secondary medical data associated with the primary patient;
determine, based on the extracted medical data associated with the life event, the extracted secondary medical data associated with the primary patient, and a set of medical dictionaries and rules, a medical condition for the primary patient; and
transmit, based on the determining the medical condition, a relationship between the life event and the medical condition.

13. The computer system of claim 12, wherein the medical records include unstructured data.

14. The computer system of claim 12, wherein the set of medical records associated with each of the secondary patients includes unstructured data.

15. The computer system of claim 12, wherein the at least one processor circuit is further configured to perform text analytics on the set of medical records, prior to the identification of the life event.

16. The computer system of claim 15, wherein the performance of text analytics on the set of medical records comprises sorting medical records data into categories, wherein each category is associated with a particular aspect of a medical concept.

17. A computer program product for identifying a relationship between a life event and a medical condition, the computer program product comprising a computer readable storage medium having program instructions embodied therewith, wherein the computer readable storage medium is not a transitory signal per se, the program instructions executable by a computer processing circuit to cause the circuit to perform a method comprising:
identifying a life event for a primary patient, the identifying based on results of text analytics performed on a set of medical records;
extracting, from the set of medical records, medical data associated with the life event, the medical data being associated by occurring in a time frame of the life event;
determining the life event of the primary patient impacts a set of secondary patients;
analyzing, for each secondary patient in the set of secondary patients, a set of medical records associated with each secondary patient in the set of secondary patients, the analyzing resulting in the identification of secondary medical data, the secondary medical data associated with the primary patient;
extracting, based on the analyzing for each secondary patient, the secondary medical data associated with the primary patient;
determining, based on the extracted medical data associated with the life event, the extracted secondary medical data associated with the primary patient, and a set of medical dictionaries and rules, a medical condition for the primary patient; and
transmitting, based on the determining the medical condition, a relationship between the life event and the medical condition.

18. The computer program product of claim 17, wherein the set of medical dictionaries and rules comprise data mined from sources accessed over the Internet.

19. The computer program product of claim 17, wherein the medical records include unstructured data.

20. The computer program product of claim 17, wherein the method further comprises, prior to the identifying the life event for the primary patient, performing text analytics on the set of medical records.
